(19) United States
(12) Patent Application Publication
(10) Pub. No.: US 2026/0050186 A1
(43) Pub. Date: Feb. 19, 2026

(54) LCD module with a built-in heat-dissipating system and projector

(71) Applicant: ELEPN Projection Display Technology Co., Ltd., Shenzhen (CN)

(72) Inventors: Haipeng LIU, Shenzhen (CN); Yichang WU, Shenzhen (CN); Xiaocao GAO, Shenzhen (CN)

(73) Assignee: ELEPN Projection Display Technology Co., Ltd., Shenzhen (CN)

(21) Appl. No.: 19/015,600

(22) Filed: Jan. 9, 2025

(30) Foreign Application Priority Data
Aug. 16, 2024 (CN) 202411127075.6

(51) Int. Cl. G02F 1/1333; G03B 21/16

(52) U.S. Cl. CPC G02F 1/133385; G03B 21/16

(57) ABSTRACT

An LCD module comprising a light-transmitting element, a mounting frame body and an LCD screen, wherein the light-transmitting element and the LCD screen are arranged at intervals on the mounting frame body, and a closed cooling cavity is formed between the light-transmitting element, the mounting frame body and the LCD screen. One end of the mounting frame body is provided with a double-layer structure comprising a hollow structure and a miniature water pump and the double-layer structure divides the cooling cavity into an upper cooling cavity and a lower cooling cavity. The miniature water pump drive cooling liquid to circulate internally between the upper cooling cavity and the lower cooling cavity through the hollow structure, a mounting frame sealing plate is arranged on the double-layer structure, and the LCD module with a built-in heat-dissipating system further comprises a heat sink fixedly connected to the mounting frame sealing plate.

### INCORPORATION BY REFERENCE

This application claims the benefit of priority from China Patent Application No. 202411127075.6 filed on Aug. 16, 2024, the contents of which are hereby incorporated by reference in their entirety.

### TECHNICAL FIELD

The present invention relates to the technical field of projection, in particular, to an LCD module with a built-in heat-dissipating system and a projector.

### BACKGROUND TECHNOLOGY

LCD technology is a mature and low-cost projection technology, the advantages of which lie in clear projected images, high color saturation, and affordable price. In order to pursue higher brightness, optical-mechanical modules using LCD usually adopt high-power light sources. When light passes through a LCD screen, a considerable proportion of the light is absorbed by the LCD screen and converted into heat, which increases a temperature of the LCD screen and affects the display effect and service life of the LCD. Therefore, it is necessary to sufficiently dissipate heat from the LCD screen. The heat-dissipating solution of existing LCD mainly adopts air cooling, but an air cooling system has problems such as easy introduction of dust and low heat conduction efficiency, which will affect the imaging effect and service life of the LCD.

With an improvement of display resolution and refresh rate, and an increase of driving voltage of liquid crystal panel, a heating problem of LCD screen has become increasingly serious. A Chinese patent with application No. CN118192149A discloses an optical component that uses a liquid cooling solution to dissipate heat for LCD screen. The LCD screen and other optical components are integrated with coolant through a mounting frame, and the coolant is circulated in three liquid cooling cavities and external pipes to take away the heat of the LCD screen and other optical components, which is then transferred to an external space through external circulation heat pipes and radiators. This optical component can achieve the heat-dissipating requirements of the LCD screen. However, this optical component still needs to be equipped with external heat pipes, coolant storage tanks and water pumps to complete heat transfer, which takes up a large volume. Meanwhile, this solution will cause brightness attenuation because there are multiple cooling cavities arranged on an optical path of the LCD screen, which will also affect stability of a projection picture and projection effect. Therefore, the existing heat-dissipating solution of LCD is required to be improved.

### SUMMARY OF THE INVENTION

In the prior art, external heat pipes and other structures of a LCD liquid cooling solution occupy a large volume, and at the same time, a plurality of cooling cavities are arranged on an optical path of a LCD screen, which will cause brightness attenuation and affect stability of projection pictures, resulting in a poor projection effect. Therefore, the present invention provides an LCD module with a built-in heat-dissipating system and a projector for solving the above problems.

In a first aspect, the present invention provides an LCD module with a built-in heat-dissipating system comprising a light-transmitting element, a mounting frame body and an LCD screen, wherein the light-transmitting element and the LCD screen are arranged at intervals on an inner peripheral side of the mounting frame body, a closed cooling cavity is formed between the light-transmitting element, the mounting frame body and the LCD screen, one end of the mounting frame body far away from the LCD screen is provided with a double-layer structure comprising a hollow structure and a miniature water pump, the double-layer structure divides the cooling cavity into an upper cooling cavity and a lower cooling cavity, the miniature water pump drive cooling liquid to circulate internally between the upper cooling cavity and the lower cooling cavity through the hollow structure, a mounting frame sealing plate is arranged on an side of the double-layer structure close to the LCD screen, and the LCD module with a built-in heat-dissipating system further comprises a heat sink fixedly connected to the mounting frame sealing plate.

According to an embodiment of the present invention, the upper cooling cavity is located on a side close to the light-transmitting element and a protrusion is provided on an edge of the mounting frame body close to the light-transmitting element, with the cooling liquid entering the upper cooling cavity through the hollow structure, flowing along the protrusion to merge at an end of the protrusion, flowing back in an opposite direction to the lower cooling cavity through the miniature water pump, and then entering the upper cooling cavity through the hollow structure to form a circulation.

According to an embodiment of the present invention, the light-transmitting element, the mounting frame body and the LCD screen are connected by a sealing ring or a sealant.

According to an embodiment of the present invention, the light-transmitting element is provided with a connection port corresponding to a surface of the miniature water pump, and the connection port is configured for a connecting rod of the miniature water pump and a motor to pass through.

According to an embodiment of the present invention, the LCD module with a built-in heat-dissipating system further comprises a first polarizing film and a second polarizing film, wherein the first polarizing film is provided on a side of the LCD screen away from the cooling cavity, and the second polarizing film is provided on a side of the LCD screen close to the cooling cavity.

According to an embodiment of the present invention, the LCD module with a built-in heat-dissipating system further comprises a first polarizing film and a second polarizing film, wherein the first polarizing film is provided on a side of the LCD screen away from the cooling cavity, and the second polarizing film is provided on a side of the light-transmitting element close to the cooling cavity.

According to an embodiment of the present invention, the LCD module with a built-in heat-dissipating system further comprises a first polarizing film and a second polarizing film, wherein the first polarizing film is provided on a side of the LCD screen away from the cooling cavity, and the second polarizing film is provided on a side of the light-transmitting element away from the cooling cavity.

According to an embodiment of the present invention, the mounting frame sealing plate is a refrigeration sheet.

According to an embodiment of the present invention, a thickness of a coolant layer on a surface of the LCD screen is 3 to 4 mm.

In a second aspect, the present invention further provides a projector comprising the LCD module with a built-in heat-dissipating system as described in any one of the above.

Beneficial effects: The LCD module with a built-in heat-dissipating system and projector provided by the present invention are configured with the miniature water pump and the cooling cavity to realize an internal circulation of the cooling liquid between the upper cooling cavity and the lower cooling cavity through the hollow structure, a structure of the cooling cavity can achieve a more uniform and rapid heat-dissipating effect, and can also promote polarization performance of light and contrast ratio of projection pictures, thereby providing the LCD module and the projector with a good heat-dissipating effect and a small volume.

### BRIEF DESCRIPTION OF THE DRAWINGS

FIG. 1 is a schematic diagram of a front structure of an LCD module with a built-in heat-dissipating system according to the present invention;

FIG. 2 is a schematic diagram of a back structure of the LCD module with a built-in heat-dissipating system shown in FIG. 1;

FIG. 3 is a schematic diagram of a partially disassembled structure of the LCD module with a built-in heat-dissipating system shown in FIG. 1;

FIG. 4 is a schematic diagram of the partially disassembled structure of the LCD module with a built-in heat-dissipating system according to another embodiment of the present invention;

FIG. 5 is a schematic diagram of a partial structure of the LCD module with a built-in heat-dissipating system shown in FIG. 1;

FIG. 6 is a schematic diagram of a flow direction of cooling liquid of the LCD module with a built-in heat-dissipating system shown in FIG. 1.

The markups in the drawings are indicated as follows:

10—light-transmitting element; 11—connection port; 20—mounting frame body; 21—double-layer structure; 211—hollow structure; 212—miniature water pump; 22—provision; 30—LCD screen; 40—mounting frame sealing plate; 50—heat sink; 60—first polarizing film; 70—second polarizing film.

The realization of purpose, functional features and advantages of the present invention will be more clearly understood from the following detailed description taken in conjunction with the accompanying drawings.

### SPECIFIC EMBODIMENTS

The following description of the specific embodiment(s) is merely exemplary in nature and is in no way intended to limit the present invention.

It will be appreciated by those skilled in the art that the singular forms “one”, “a”, “said”, “above” and “the” as used herein may also refer to the plural forms, unless otherwise stated.” and “the” may also include the plural form. It should be further understood that the word “comprising” as used in the specification of the present invention refers to the presence of the said features, integers, steps, operations, elements, units, modules and/or components, but does not exclude the presence or addition of one or more other features, integers, steps, operations, elements, units, modules, components and/or groups thereof. It should be understood that an element is “connected” or “coupled” to another element, it may be directly connected or coupled to the other element, or there may be intermediate elements. In addition, “connected” or “coupled” as used herein may include wirelessly connected or wirelessly coupled. The term “and/or” as used herein includes all or any of the units and all combinations of one or more associated listed items.

It will be understood by those skilled in the art that all terms used herein, including technical and scientific terms, unless otherwise defined, have the same meaning as generally understood by those of ordinary skill in the art to which the present invention belongs. It should also be understood that terms such as those defined in common dictionaries should be understood to have meanings consistent with the meanings in the context of the prior art, and will not be interpreted with idealized or overly formal meanings unless specifically defined as here.

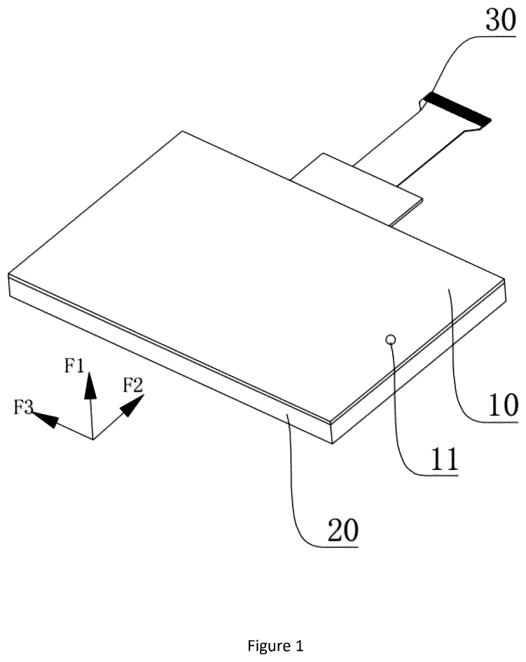

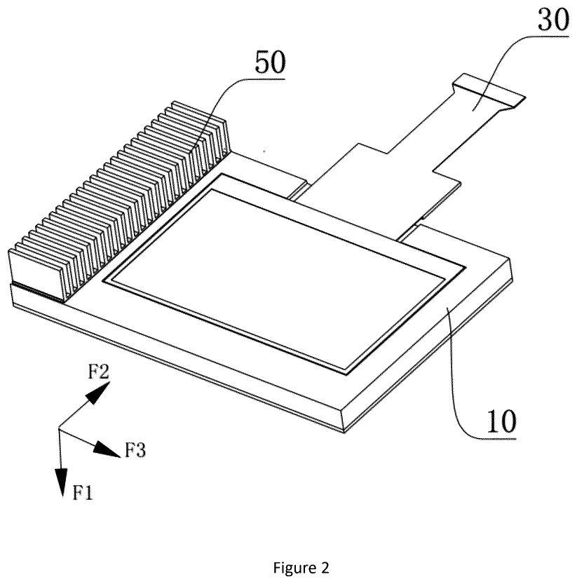

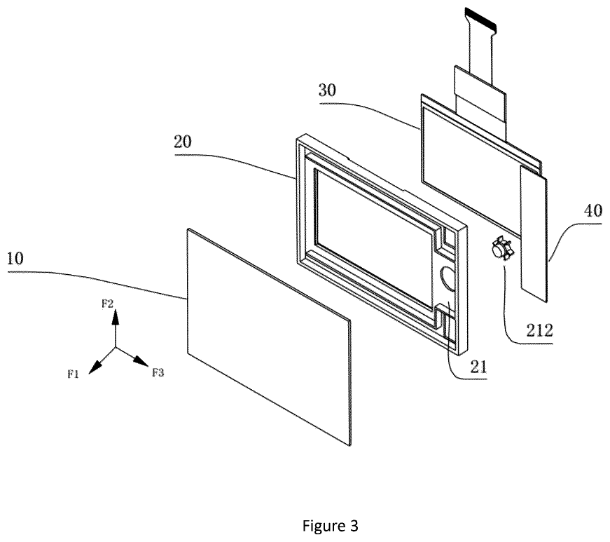

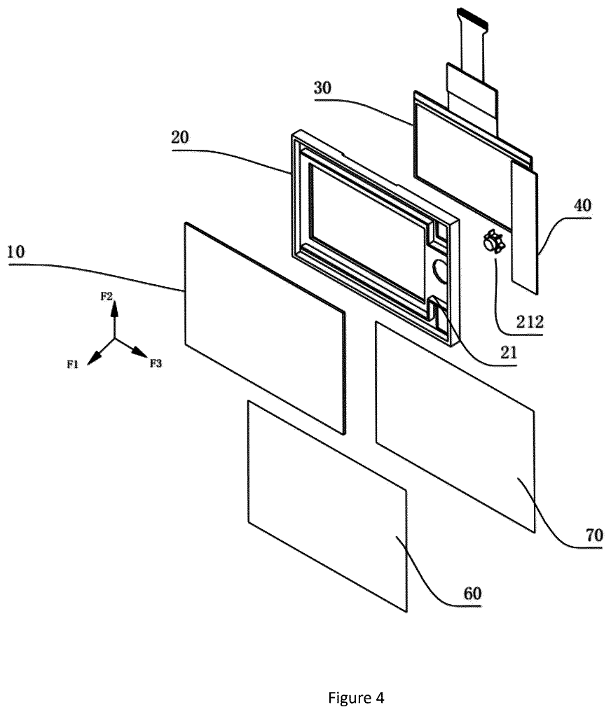

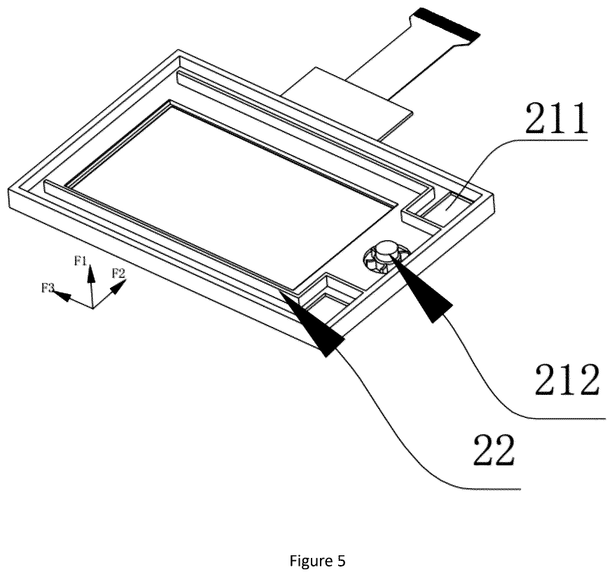

With reference to FIGS. 1 to 5, FIG. 1 is a schematic diagram of a front structure of an LCD module with a built-in heat-dissipating system according to the present invention, FIG. 2 is a schematic diagram of a back structure of the LCD module with a built-in heat-dissipating system shown in FIG. 1, FIG. 3 is a schematic diagram of a partially disassembled structure of the LCD module with a built-in heat-dissipating system shown in FIG. 1, FIG. 4 is a schematic diagram of the partially disassembled structure of the LCD module with a built-in heat-dissipating system according to another embodiment of the present invention, and FIG. 5 is a schematic diagram of a partial structure of the LCD module with a built-in heat-dissipating system shown in FIG. 1.

In a first aspect, the present invention provides an LCD module with a built-in heat-dissipating system comprising a light-transmitting element 10, a mounting frame body 20 and an LCD screen 30, wherein the light-transmitting element 10 and the LCD screen 30 are arranged at intervals on an inner peripheral side of the mounting frame body 20, a closed cooling cavity is formed between the light-transmitting element 10, the mounting frame body 20 and the LCD screen 30, one end of the mounting frame body 20 far away from the LCD screen is provided with a double-layer structure 21 comprising a hollow structure 211 and a miniature water pump 212, the double-layer structure 21 divides the cooling cavity into an upper cooling cavity and a lower cooling cavity, the miniature water pump 212 drive cooling liquid to circulate internally between the upper cooling cavity and the lower cooling cavity through the hollow structure, a mounting frame sealing plate 40 is arranged on an side of the double-layer structure 21 close to the LCD screen 30, and the LCD module with a built-in heat-dissipating system further comprises a heat sink 50 fixedly connected to the mounting frame sealing plate 40.

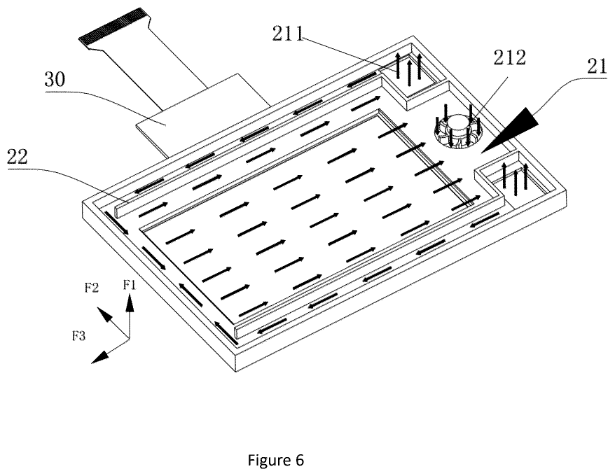

With reference to FIG. 6, FIG. 6 is a schematic diagram of a flow direction of cooling liquid of the LCD module with a built-in heat-dissipating system shown in FIG. 1. The upper cooling cavity is located on a side close to the light-transmitting element 10 and a protrusion 22 is provided on an edge of the mounting frame body 20 close to the light-transmitting element 10, with the cooling liquid entering the upper cooling cavity through the hollow structure 211, flowing along the protrusion 22 to merge at an end of the protrusion 22, flowing back in an opposite direction to the lower cooling cavity through the miniature water pump 212, and then entering the upper cooling cavity through the hollow structure 211 to form a circulation. Specifically, the miniature water pump 212 drives the cooling liquid to circulate in a whole cooling cavity under action of a motor: the cooling liquid enters a lower structure of the cooling cavity from the miniature water pump 212, passes through the hollow structure 211 through the lower structure of the cooling cavity, enters an upper structure of the cooling cavity along a direction F1, flows along the protrusion 22 to a direction F3, merges in a middle portion along forward and reverse directions after reaching an end, flows back in the reverse direction of F3, flows through the LCD screen 30 to take away heat on the LCD screen 30, and then flows into the lower structure of the cooling cavity along the reverse direction of F1 through the miniature water pump 212, forming an internal circulation of heat dissipation.

Specifically, the light-transmitting element 10, the mounting frame body 20 and the LCD screen 30 are connected by a sealing ring or a sealant. The light-transmitting element 10 is provided with a connection port 11 corresponding to a surface of the miniature water pump 212, and the connection port 11 is configured for a connecting rod (not shown in accompanying drawings) of the miniature water pump 212 and a motor to pass through.

With reference to FIG. 4, FIG. 4 is a schematic diagram of the partially disassembled structure of the LCD module with a built-in heat-dissipating system according to another embodiment of the present invention. Further, in some embodiments, the LCD module with a built-in heat-dissipating system further comprises a first polarizing film 60 and a second polarizing film 70, with the first polarizing film 60 provided on a side of the LCD screen 30 away from the cooling cavity, and the second polarizing film 70 provided on a side of the LCD screen 30 close to the cooling cavity. In some embodiments, the second polarizing film 70 is provided on a side of the light-transmitting element 10 close to the cooling cavity. In other embodiments, the second polarizing film 70 may also be provided on a side of the light-transmitting element 10 away from the cooling cavity. A structure of the first polarizing film 60 and the second polarizing film 70 combined with the cooling cavity can achieve a more uniform and rapid heat-dissipating effect, and can also ensure polarization performance of light and contrast of projection pictures.

Preferably, the light-transmitting element 10 is a Fresnel lens including a light-transmitting portion of the Fresnel lens and a peripheral portion of the Fresnel lens provided around the light-transmitting portion of the Fresnel lens. In other embodiments, the light-transmitting element 10 may also be a flat plate made of flat glass or other light-transmitting material.

Specifically, the mounting frame body 20 is made of any one or more materials with good sealing properties, impermeability to air or water, and is integrally molded or assembled. Preferably, an outer frame of the mounting frame body 20 is made of a material with good thermal conductivity, such as metal copper or aluminum.

Specifically, the mounting frame sealing plate 40 may be any material having good sealing properties, or may be a refrigeration sheet, which is placed on a lower layer of the double-layer structure 21 and can completely seal the lower layer of the double-layer structure 21. Preferably, the mounting frame sealing plate 40 is a refrigeration sheet, one side of the mounting frame sealing plate 40 is configured for sealing the double-layer structure 21, and an other side is mounted with a heat sink 50 for exporting heat from the refrigeration sheet. Specifically, the mounting frame sealing plate 40 is a semiconductor refrigeration sheet, and the semiconductor refrigeration sheet can generate different heat on both sides of a semiconductor sheet by applying a voltage based on Peltier effect, with one side of the semiconductor refrigeration sheet absorbing heat and the other side releasing heat, thereby achieving a refrigeration effect. When the semiconductor cooling sheet is used as a sealing plate, the semiconductor cooling sheet can absorb heat inside a sealing area, lower a temperature of the sealing area, effectively reduce a temperature of internal components, reduce impacts of heat on components, and meanwhile play a sealing role to prevent external media such as air and water vapor from entering the sealing area, protect internal devices and components, and adjust operating the temperature as needed to keep internal temperatures of the sealing area constant to prevent internal components from being damaged due to temperature changes.

Specifically, the cooling cavity surrounded by the light-transmitting element 10, the mounting frame body 20, and the LCD screen 30 is filled with transparent cooling liquid. Preferably, a thickness of a cooling liquid layer on the surface of the LCD screen 30 is 3 to 4 mm, that is, the thickness of the upper cooling cavity is 3 to 4 mm. A thinner cooling cavity structure can achieve more uniform and faster heat-dissipating effect, and can also ensure the polarization performance of light and the contrast of projection pictures.

The miniature water pump 212 drives the cooling liquid to circulate in the cooling cavity, and the cooling liquid passes through a lighted LCD screen 30, takes away the heat on the LCD screen 30, transfers heat to the mounting frame sealing plate 40 and/or the mounting frame body 20, and then transfers the heat to the heat sink 50 to realize heat transfer.

The present invention also provides a heat-dissipating adjustment method of the LCD module with a built-in heat-dissipating system, which adopts the LCD module with a built-in heat-dissipating system provided by the present invention, and the mounting frame sealing plate 40 is the semiconductor refrigeration sheet, the method specifically comprising following steps:
S1: setting a temperature sensor: setting a temperature sensor in the LCD module for monitoring a temperature of the LCD module in real time;
S2: monitoring a heat-dissipating state: monitoring data of the heat-dissipating state for the LCD module through a software program, including a working state of the miniature water pump, a temperature of a heat-dissipating fin, a temperature of the semiconductor refrigeration sheet, a temperature of the upper cooling cavity and a temperature of the lower cooling cavity;
S3: adjusting the working state of the miniature water pump: adjusting the working state of the miniature water pump and/or the semiconductor refrigeration sheet through a control system according to the data monitored by the temperature sensor and the heat-dissipating state; and
S4: real-time feedback: feeding back the temperature and data of the heat-dissipating state for the LCD module to the control system, and timely adjusting the working state of the miniature water pump and/or the semiconductor refrigeration sheet.

Specifically, in the S3, three temperature values are set in advance, namely T1, T2, and T3, respectively, where T1<T2<T3, and when the temperature of the LCD module is too high or the heat-dissipating state is not good, the control system determines the temperature of the temperature sensor. When the temperature sensor reaches T1, the semiconductor cooling sheet is activated; When the temperature reaches the T2, the semiconductor refrigeration sheet and the micro water pump are started at the same time, the rotating speed of the miniature water pump is turned on to a first value, and the temperature of the LCD module is reduced by combining the semiconductor refrigeration sheet with liquid cooling; When the temperature reaches the T3, a rotational speed of the miniature water pump is increased from the first value to a second value to accelerate the internal circulation of the cooling liquid. When the temperature of the temperature sensor drops less than the T3, the control system reduces the rotational speed of the miniature water pump from the second value to the first value; When the temperature of the temperature sensor drops below the T2, the miniature water pump is turned off; When the temperature of the temperature sensor drops below the T1, the semiconductor cooling sheet is turned off.

In addition, when the semiconductor refrigeration sheet is turned on separately, the control system further needs to obtain a temperature of the semiconductor refrigeration sheet required for lowering a real-time temperature below a preset temperature at different real-time temperatures, and a current value corresponding to the temperature of the semiconductor refrigeration sheet.

In general, the LCD module with a built-in heat-dissipating system and the projector provided by the present invention are configured with the miniature water pump and the cooling cavity to realize the internal circulation of the cooling liquid between the upper cooling cavity and the lower cooling cavity through the hollow structure, so that the heat-dissipating effect is more uniform and rapid, and the polarization performance of light and the contrast ratio of projection pictures can be ensured, thereby providing the LCD module and the projector with an excellent heat-dissipating effect and a small volume.

The foregoing detailed description is merely exemplary in nature and no unnecessary limitations should be understood therefrom. Any equivalent structure or equivalent process transformation made utilizing the contents of the specification and drawings, or direct or indirect application in other related technical fields, shall be included in the protection scope of the present invention.

What is claimed is:

1. An LCD module with a built-in heat-dissipating system comprising a light-transmitting element, a mounting frame body and an LCD screen, wherein the light-transmitting element and the LCD screen are arranged at intervals on an inner peripheral side of the mounting frame body, a closed cooling cavity is formed between the light-transmitting element, the mounting frame body and the LCD screen, one end of the mounting frame body far away from the LCD screen is provided with a double-layer structure comprising a hollow structure and a miniature water pump, the double-layer structure divides the cooling cavity into an upper cooling cavity and a lower cooling cavity, the miniature water pump drive cooling liquid to circulate internally between the upper cooling cavity and the lower cooling cavity through the hollow structure, a mounting frame sealing plate is arranged on an side of the double-layer structure close to the LCD screen, and the LCD module with a built-in heat-dissipating system further comprises a heat sink fixedly connected to the mounting frame sealing plate; the upper cooling cavity is located on a side close to the light-transmitting element and a protrusion is provided on an edge of the mounting frame body close to the light-transmitting element, with the cooling liquid entering the upper cooling cavity through the hollow structure, flowing along the protrusion to merge at an end of the protrusion, flowing back in an opposite direction to the lower cooling cavity through the miniature water pump, and then entering the upper cooling cavity through the hollow structure to form a circulation.

2. The LCD module with a built-in heat-dissipating system according to claim 1, wherein the light-transmitting element, the mounting frame body and the LCD screen are connected by a sealing ring or a sealant.

3. The LCD module with a built-in heat-dissipating system according to claim 1, wherein the light-transmitting element is provided with a connection port corresponding to a surface of the miniature water pump, and the connection port is configured for a connecting rod of the miniature water pump and a motor to pass through.

4. The LCD module with a built-in heat-dissipating system according to claim 1 further comprising a first polarizing film and a second polarizing film, wherein the first polarizing film is provided on a side of the LCD screen away from the cooling cavity, and the second polarizing film is provided on a side of the LCD screen close to the cooling cavity.

5. The LCD module with a built-in heat-dissipating system according to claim 1 further comprising a first polarizing film and a second polarizing film, wherein the first polarizing film is provided on a side of the LCD screen away from the cooling cavity, and the second polarizing film is provided on a side of the light-transmitting element close to the cooling cavity.

6. The LCD module with a built-in heat-dissipating system according to claim 1 further comprising a first polarizing film and a second polarizing film, wherein the first polarizing film is provided on a side of the LCD screen away from the cooling cavity, and the second polarizing film is provided on a side of the light-transmitting element away from the cooling cavity.

7. The LCD module with a built-in heat-dissipating system according to claim 1, wherein the mounting frame sealing plate is a refrigeration sheet.

8. The LCD module with a built-in heat-dissipating system according to claim 1, wherein a thickness of a coolant layer on a surface of the LCD screen is 3 to 4 mm.

9. A projector comprising the LCD module with a built-in heat-dissipating system according to claim 1.
